(19) United States
(12) Patent Application Publication
(10) Pub. No.: US 2014/0324923 A1
(43) Pub. Date: Oct. 30, 2014

(54) COMPUTER SYSTEM, DATA MANAGEMENT METHOD, AND NON-TRANSITORY COMPUTER READABLE MEDIUM

(71) Applicant: Yuki Sugimoto, Tokyo (JP)

(72) Inventor: Yuki Sugimoto, Tokyo (JP)

(73) Assignee: HITACHI, LTD., Tokyo (JP)

(21) Appl. No.: 14/364,924

(22) PCT Filed: Feb. 9, 2012
(86) PCT No.: PCT/JP2012/052959

§ 371 Date: Jun. 12, 2014

(51) Int. Cl. G06F 17/30

(52) U.S. Cl. CPC G06F 17/30312
USPC 707/812

(57) ABSTRACT

A computer system comprising a plurality of computers coupled through a network, the computer system performing service by using a database constructed of a storage area of each of the plurality of computers, wherein a plurality of pieces of data are arranged in a distributed manner in units of a management range in each of the plurality of computers constructing the database, the management range being determined by applying a distributed algorithm to identification information on data, and the computer system comprises: a management range managing unit to manage the plurality of pieces of data arranged in a distributed manner in each of the plurality of computers; and a specific data managing unit to allocate a specific area to at least one of piece of specific data being at least one of piece of data included in the management range.

### BACKGROUND OF THE INVENTION

This invention relates to a distributed database composed of multiple computers. This invention particularly relates to a technique of managing data in the distributed database.

In recent years, a calculation system to execute an application on the Web has encountered an explosively increased amount of data and a computer system with a NoSQL (not only SQL) database such as KVS (key-value store) has become popular. Such a system is now being introduced into various enterprise systems and is expected to be used more practically in the future.

KVS employs various structures including a structure where data is stored in a volatile storage medium such as a memory that allows high-speed access to data, a structure where data is stored in a nonvolatile recording medium such as an SSD (solid state disk) or a HDD exhibiting excellence in maintaining data permanently, and a structure of using these structures in combination. In a case where these structures are used in combination, a memory store composed of virtually integrated memories of multiple computers and a disk store composed of a nonvolatile storage medium of one or more computers can be changed in balance in various ways depending on a wide-ranging running policy putting weight on high-speed accessibility or permanence, for example.

The memory store and the disk store data including data (value) and an identifier of the data (key) in a pair.

According to KVS, multiple servers construct a cluster and a plurality of pieces of the data is arranged in a distributed manner in the servers belonging to the cluster, thereby realizing parallel process. More specifically, each server stores the plurality of pieces of data in units of a management range (key range) of a key. Each server executes process as a master of a plurality of pieces of data included in an associated key range. Specifically, in response to a read request including a certain key, a server, which handles the plurality of pieces of data in a key range including this key, reads data corresponding to the key.

Thus, KVS can enhance the performance of parallel process by means of scale out.

The cluster is composed of servers connected in a ring pattern. Each server is given an allocated unique identification number. A method of distributing data to each server employs various distributed algorithms including consistent hashing method, range method and list method, for example.

According to consistent hashing method, a hash value of a key is calculated first, and then a remainder resulting from division of the calculated hash value by the number of servers is obtained. Each of the plurality of pieces of data is allocated to a server with an identification number in agreement with this remainder.

According to KVS, distribution of a load on a server has conventionally been handled by addition or rebalancing of a server.

As an example, addition of a server such as scale in and scale out is described in Japanese Patent Application Publication No. 2009-123238 describes. Rebalancing is described on pp. 490 and 491 of HiRDB Version 9 System Operation Guide (3020-6-454-20). The rebalancing mentioned herein is process of changing a range of a hash value (key) in response to fluctuations of a load on each server and moving at least one of piece of data corresponding to the range to a different server.

Japanese Patent Application Publication No. 2011-118525 recites that fluctuations of a load on a computer targeted for management are predicted based on a history of fluctuations of a load observed in the past, and then scale in or scale out is performed based on a result of the prediction.

### SUMMARY OF THE INVENTION

Making addition of a server in response to a temporary load entails processing cost, and making addition of a server also involves addition of an unnecessary resource, increasing facility cost. While the conventional rebalancing could move the at least one of piece of data in a certain key range so as to even up a load, it cannot be responsive to a momentarily fluctuating load.

Addition and rebalancing of a server are intended to level a load and do not handle only a specific key specially. Addition and rebalancing of a server cannot enhance the performance in accessing a specific key or manage the specific key in a storage area different from KVS in terms of security.

This invention has been made in view of the aforementioned problems. Specifically, this invention is intended to provide a computer system and a management method capable of managing only a specific key specially.

The present invention can be appreciated by the description which follows in conjunction with the following figures, wherein: a computer system comprises a plurality of computers coupled through a network; the computer system performs service by using a database constructed of a storage area of each of the plurality of computers. Each of the plurality of computers includes a processor, a memory coupled to the processor, and a network interface for communicating with another computer via the network which is coupled to the processor. A plurality of pieces of data are arranged in a distributed manner in units of a management range in each of the plurality of computers constructing the database, the management range being determined by applying a distributed algorithm to identification information on data. The computer system comprises: a management range managing unit to manage the plurality of pieces of data arranged in a distributed manner in each of the plurality of computers constructing the database; and a specific data managing unit to allocate a specific area to at least one of piece of specific data being at least one of piece of data included in the management range, the specific area being a storage area different from the storage area constructing the database.

According to this invention, a piece of data included in a management range can be managed specially in a storage area different from a storage area constructing a database. Where this data is to be accessed frequently, for example, this invention does not cause degradation of the access performance of a computer constructing the database and achieves high-speed process on this data.

### BRIEF DESCRIPTION OF THE DRAWINGS

The present invention can be appreciated by the description which follows in conjunction with the following figures, wherein:

FIG. 1 is a block diagram illustrating a structure of a computer system of a first embodiment of this invention,

FIG. 2 is an explanatory diagram showing a format of data stored in a memory store and a disk store of the first embodiment of this invention,

FIG. 3 is an explanatory diagram showing an example of structure information of the first embodiment of this invention

FIG. 4 is an explanatory diagram showing an example of correspondence relation between a key and a hash value of the first embodiment of this invention,

FIG. 5 is an explanatory diagram showing an example of specific key management information of the first embodiment of this invention,

FIG. 6 is an explanatory diagram showing an example of statistical information of the first embodiment of this invention,

FIG. 7 is a flowchart illustrating process executed by a client device of the first embodiment of this invention,

FIG. 8 is a flowchart illustrating process executed by a specific key managing unit of the first embodiment of this invention,

FIG. 9 is an explanatory diagram showing an example of an entry screen for a specific key condition of the first embodiment of this invention,

FIG. 10 is a flowchart illustrating an allocation process of specific data in the first embodiment of this invention,

FIG. 11 is an explanatory diagram showing an example of a load balancing confirmation screen of the first embodiment of this invention, and

FIG. 12 is a flowchart illustrating a process of generating a specific key condition in the second embodiment of this invention.

### DETAILED DESCRIPTION OF THE PREFERRED EMBODIMENTS

### First Embodiment

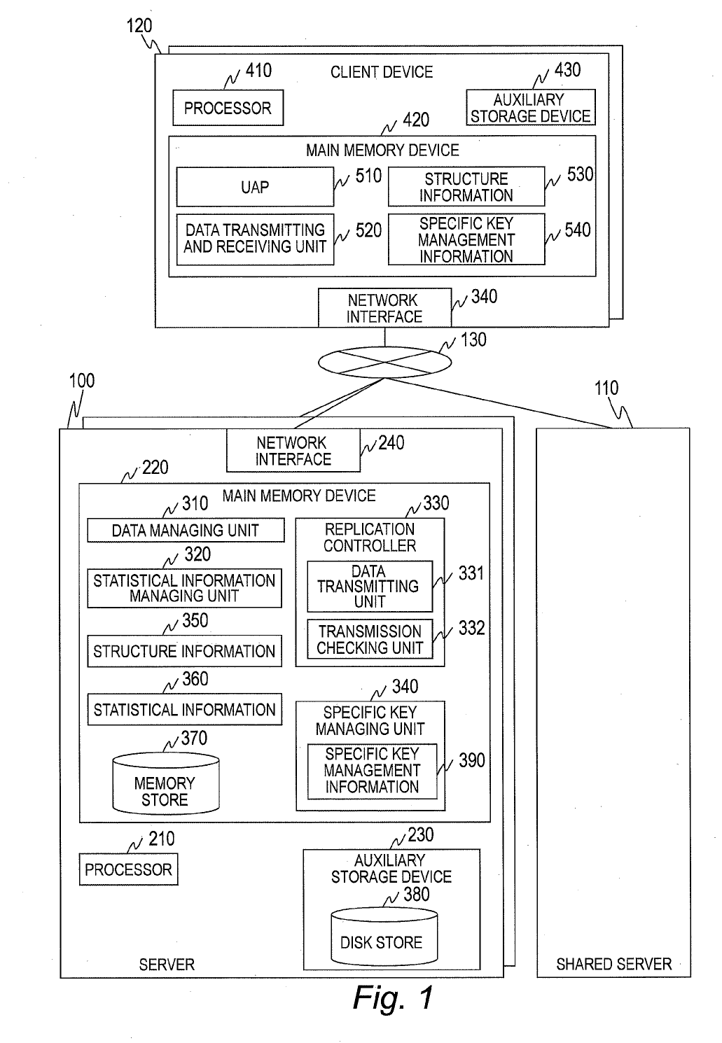

FIG. 1 is a block diagram illustrating the structure of a computer system of a first embodiment of this invention.

The computer system is composed of multiple servers 100, a shared server 110, multiple client devices 120, and a network 130. The network 130 connects the servers 100, connects the servers 100 and the shared server 110, and connects the servers 100 and the client devices 120.

The network 130 may have various structures a wire or a wireless such as a LAN, a WAN, and an SAN. This invention can employ any network that allows communications of the servers 100, the shared server 110, and the client devices 120. The network 130 includes multiple network devices (not shown in the drawings). The network devices include switches and gateways, for example.

In the first embodiment, the servers 100 construct a cluster and a NoSQL database is constructed in a storage area of each of the servers 100. In the first embodiment, KVS is used as the NoSQL database.

The shared server 110 provides a storage area different from KVS. At least one of piece of data satisfying a specific condition is stored in the storage area provided by the shared server 110. Thus, the at least one of piece of specific data can be handled separately from a plurality of pieces of data stored in a distributed manner in KVS. In the first embodiment, at least one of piece of data subjected to centralization of a load is stored in the shared server 110.

The server 100 includes a processor 210, a main memory device 220, an auxiliary storage device 230, and a network interface 240. The server 100 is a computer constructing KVS. The server 100 executes various processes in response to a request from the client device 120. All the servers 100 have the same structure.

The shared server 110 is a computer having the same structure as the server 100. The shared server 110 manages only at least one of piece of data corresponding to a key satisfying a specific condition. In the first embodiment, a piece of data to be subjected to temporary access concentration is stored in advance in the shared server 110. The shared server 110 manages data temporarily stored therein.

This can suppress reduction of the access performance of a specific server 100 and can process a piece of specific data at high speed. Thus, access performance throughout the system can be maintained.

A condition for storage into the shared server 110 is not limited to that mentioned above. Any condition is applicable that involves necessity of managing at least one of piece of data separately from other plurality of pieces of data. As an example, an applicable condition may involve necessity of processing at least one of piece of data preferentially to other plurality of pieces of data, or necessity of managing the at least one of piece of data separately for reason of security, for example.

The server 100 stores a plurality of pieces of data in units of a certain key range and functions as a master server to manage the plurality of pieces of data included in the certain key range. The server 100 holds a plurality of pieces of replicated data of a plurality of pieces of data included in a key range managed by a different server 100, and functions as a slave server. In the below, data managed by a master server is also called master data, and data managed by a slave server is also called slave data.

The shared server 110 stores only a specific key and functions as a master server for the specific key. The shared server 110 may store a plurality of pieces of replicated data in a different server 100.

The cluster of the first embodiment does not include a unique server to become a management server responsible for management of the entire computer system. All the servers 100 in the cluster are handled as equivalent servers. Thus, in response to a failure occurred in one server 100, a different slave server can continue process as a new master server, so that the process can be continued while the computer system is not stopped.

The processor 210 executes a program stored in the main memory device 220. Execution of the program by the processor 210 can realize functions provided in the server 100. In the below, process being executed while a program is described as the subject of a sentence means that the program is being executed by the processor 210.

The main memory device 220 stores the program to be executed by the processor 210 and information necessary for execution of the program. The main memory device 220 may be a memory, for example.

The main memory device 220 of the first embodiment stores a program to realize a data managing unit 310, a statistical information managing unit 320, a replication controller 330, and a specific key managing unit 340. The main memory device 220 further stores as necessary information structure information 350 and statistical information 360.

The main memory device 220 also stores a memory store 370 functioning as a database to construct KVS. The memory store 370 stores a plurality of pieces of data including a key and a value in a pair. The memory store 370 of each server 100 stores data included in a certain key range. The auxiliary storage device 230 stores various types of information.

The auxiliary storage device 230 may be a HDD or an SSD, for example. The auxiliary storage device 230 stores a disk store 380 functioning as a database to construct KVS. The disk store 380 of each server 100 stores a plurality of pieces of data including a key and a value in a pair.

The following describes the program and the information stored in the main memory device 220.

The data managing unit 310 controls various processes on a plurality of pieces of data managed by the server 100. The data managing unit 310 receives an access request from the client device 120, and controls processes such as reading and writing of data based on the access request.

More specifically, the data managing unit 310 refers to the structure information 350 to search for at least one of piece of data responsive to the received access request, and transmits a result of the search result to the client device 120 having transmitted the access request.

The statistical information managing unit 320 obtains statistical information such as the number of accesses in each server 100 and updates the statistical information 360.

The replication controller 330 controls data transmission to a slave server. The replication controller 330 includes a data transmitting unit 331 and a transmission checking unit 332. The data transmitting unit 331 transmits data to a slave server. A method of determining a slave server employs a publicly known technique, so that it will not be described. The transmission checking unit 332 checks to see whether data has been transmitted to a slave server.

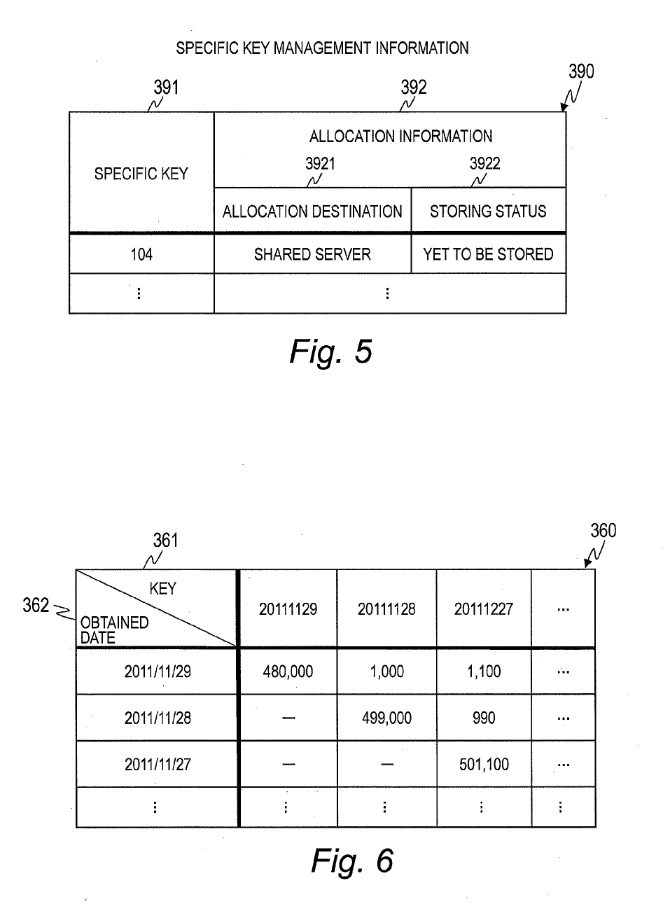

The specific key managing unit 340 manages a specific key functioning as identification information on a piece of data satisfying a specific condition. The specific key managing unit 340 includes specific key management information 390 used for managing a specific key. The specific key management information 390 will be described in detail by referring to FIG. 5.

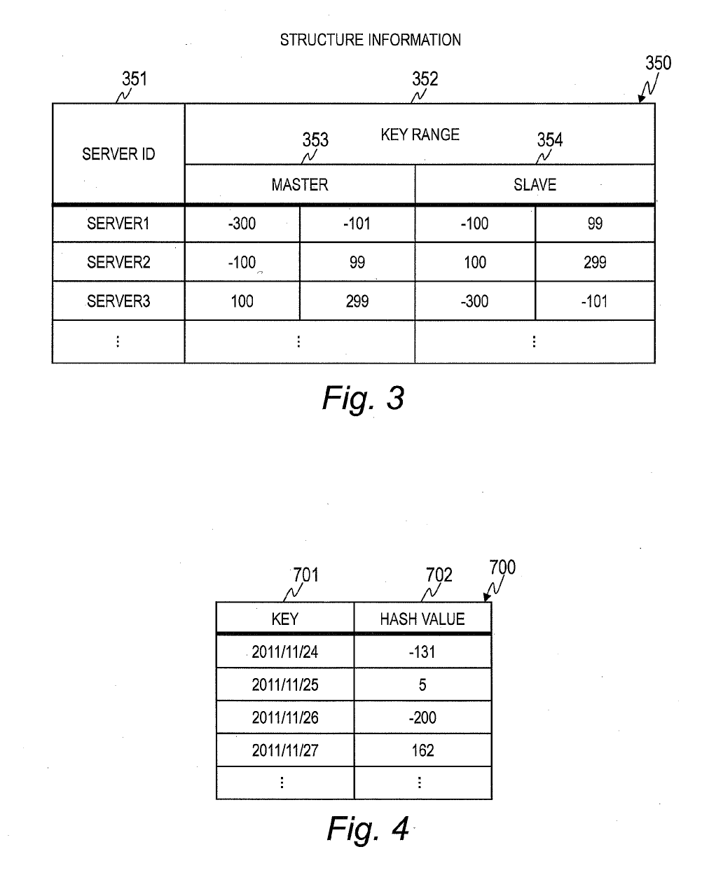

The structure information 350 stores information indicating a destination of storage of each of the plurality of pieces of data. Specifically, the structure information 350 stores information indicating a key range of each server 100. The structure information 350 will be described in detail by referring to FIG. 3. The statistical information 360 includes statistical information such as the number of accesses to each key included in a key range managed by the server 100. The statistical information 360 will be described in detail by referring to FIG. 6.

The hardware and software structures of the shared server 110 are the same as those of the server 100, so that they will not be described.

The client device 120 is described next. The client device 120 includes a processor 410, a main memory device 420, an auxiliary storage device 430, and a network interface 440. The client device 120 transmits various requests for processes to the server 100 or the shared server 110.

The processor 410 executes a program stored in the main memory device 420. Execution of the program by the processor 410 can realize functions provided in the client device 120. In the below, process being executed while a program is described as the subject of a sentence means that the program is being executed by the processor 410.

The main memory device 420 stores the program to be executed by the processor 410 and information necessary for execution of the program. The main memory device 420 may be a memory, for example.

The main memory device 420 of the first embodiment stores a program to realize an UAP 510 and a data transmitting and receiving unit 520. The main memory device 420 further stores as necessary information structure information 530 and specific key management information 540.

The auxiliary storage device 430 stores various types of information. The auxiliary storage device 430 may be a HDD or an SSD, for example.

The following describes the program and the information stored in the main memory device 420.

The UAP 510 outputs an access request in response to a user's order. The access request is output to request execution for example of reading and writing of data. The writing includes writing and overwriting of data.

The data transmitting and receiving unit 520 transmits an access request output from the UAP 510 to the server 100 or the shared server 110, and receives from the server 100 or the shared server 110 a result of process responsive to the access request. For transmission of an access request, the data transmitting and receiving unit 520 refers to the structure information 530 and the specific key management information 540 to specify the server 100 and the shared server 110 to become a destination of transmission of the access request.

The structure information 530 is the same as the structure information 350 and the specific key management information 540 is the same as the specific key management information 390, so that they will not be described.

In the first embodiment, the functions provided in the server 100, the shared server 110, and the client device 120 are realized by using software. Meanwhile, dedicated hardware may be used to realize the same functions. While one shared server 110 is provided in the first embodiment, two or more shared servers 110 may be provided.

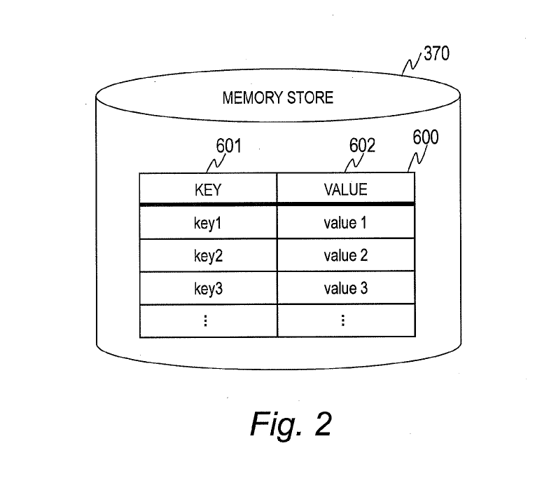

FIG. 2 is an explanatory diagram showing the format of data stored in the memory store 370 and the disk store 380 of the first embodiment of this invention. FIG. 2 shows the case of the memory store 370 as an example.

In the first embodiment, the memory store 370 stores data management information 600. The data management information 600 stores a plurality of pieces of data each including a key and a value in a pair. In the below, data including a key and a value in a pair is also called key-value data.

The data management information 600 includes key 601 and value 602. The key 601 includes an identifier (key) for identifying a piece of data. The value 602 included real data (value).

A user operating the client device 120 can store a piece of data in KVS by designating the key 601. The user can also obtain a piece of intended data from KVS by designating the key 601.

Each server 100 manages a plurality of pieces of key-value data in units of a certain range of the key 601 (key range). Specifically, each of the plurality of pieces of key-value data is arranged in a distributed manner in each server 100 in units of a key range. The server 100 becomes a master server to execute process on the plurality of pieces of data in a designated key range. This allows parallel process on a large volume of data at high speed.

Each server 100 holds a plurality of pieces of copy data of the plurality of pieces of key-value data managed in units of a certain key range by a different server 100 functioning as a master.

In the first embodiment, the shared server 110 functions as a master server for a specific key and executes process on the specific key.

The format of data stored in the memory store 370 and the disk store 380 is not limited to that shown in FIG. 2 but the data may also include a hash value of a key and a value associated with each other.

In the first embodiment, the format of the data management information 600 is such that a hash value and a value are associated with each other.

FIG. 3 is an explanatory diagram showing an example of the structure information 350 of the first embodiment of this invention.

The structure information 350 stores information about a key range of each server 100. More specifically, the structure information 350 includes server ID 351 and key range 352.

The server ID 351 includes an identifier for identifying the server 100 uniquely. The server ID 351 includes an identifier, an IP address, and an MAC address and the like of the server 100.

The key range 352 includes information indicating a key range. More specifically, the key range 352 includes master 353 and slave 354.

The master 353 includes information about a key range managed by a master server. The slave 354 contains information about a key range managed by a slave server.

The master 353 and the slave 354 each include values indicating a minimum and a maximum of a key range. The master 353 and the slave 354 include values in the form of hash values.

The example of FIG. 3 shows that the server 100 with the server ID 351 “server 1” manages a plurality of pieces of data in a hash value range of from “−300” to “−101.”

A relationship between a key and a hash value is described next by referring to FIG. 4.

In the first embodiment, a hash value is calculated from a key based on a certain algorithm. A plurality of pieces of data are arranged in a distributed manner in each server 100 based on the hash value. FIG. 4 shows a table 700 storing a date in key 701 and a hash value in hash value 702 calculated from the date.

The key 701 does not always includes only a date but it may include a key composed of a combination of user ID and a date, for example. This invention is not intended to be limited to an algorithm used for calculating a hash value.

FIG. 5 is an explanatory diagram showing an example of the specific key management information 390 of the first embodiment of this invention.

The specific key management information 390 stores information on at least one of piece of key-value data managed in a storage area different from KVS. More specifically, the specific key management information 390 includes specific key 391 and allocation information 392.

The specific key 391 includes information on a specific key that is information on a piece of key-value data managed in a storage area different from KVS. In the first embodiment, the specific key 391 includes a hash value of a key corresponding to a piece of key-value data. In the below, key-value data corresponding to a specific key is also called specific data.

The allocation information 392 includes information on the shared server 110 to store at least one of piece of specific data. More specifically, the allocation information 392 includes allocation destination 3921 and storing status 3922.

The allocation destination 3921 includes identification information about the shared server 110 to store at least one of piece of specific data. Specifically, the allocation destination 3921 includes identification information on a storage area to which at least one of piece of specific data is to be allocated to be managed specially.

The storing status 3922 includes information indicating whether the shared server 110 stores at least one of piece of specific data. In the first embodiment, in a case where at least one of piece of specific data is stored in the shared server 110, the storing status 3922 becomes “already stored”. In a case where at least one of piece of specific data is not arranged in the shared server 110, the storing status 3922 becomes “yet to be stored.”

The allocation information 392 is shown to include two columns. Meanwhile, the allocation information 392 can be formed in a format including an allocation destination and a storing status in one column.

FIG. 6 is an explanatory diagram showing an example of the statistical information 360 of the first embodiment of this invention.

The statistical information 360 is information in a matrix format composed of key 361 and obtained data 362. The key 361 indicates a key of a piece of key-value data. The obtained data 362 indicates date and time when the number of accesses to a piece of key-value data corresponding to the key 361 is obtained.

In the example of FIG. 6, the number of accesses to a piece of key-value data is stored using a date and time as a key. The number of accesses is determined per second.

In the example of FIG. 6, the number of accesses is stored daily. However, this is merely an example and is not intended to limit this invention. Statistical information can be obtained at any intervals and may be obtained hourly or weekly, for example. Statistical information can also be obtained in response to a user's order.

Each process is described next.

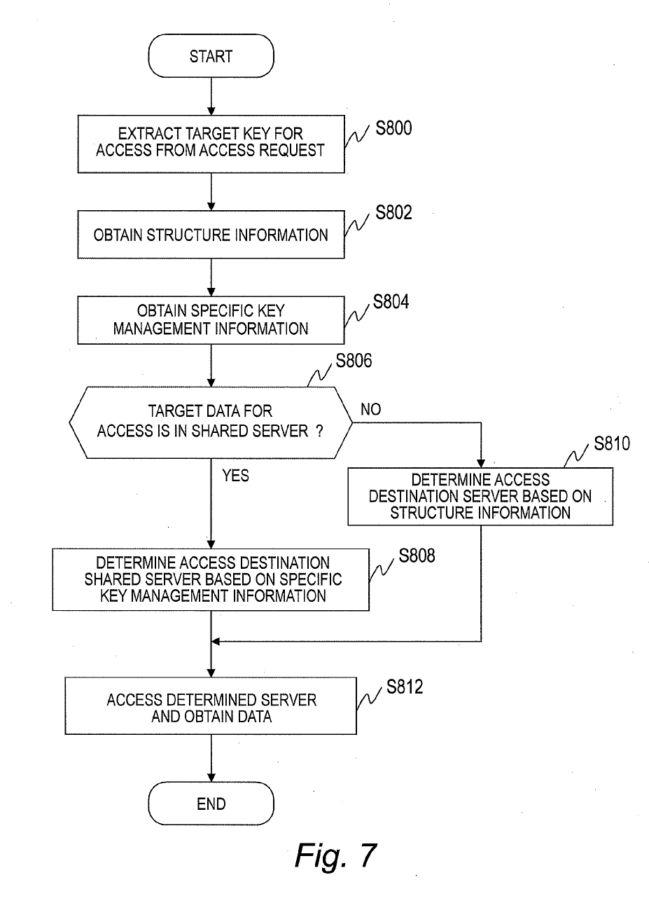

FIG. 7 is a flowchart illustrating process executed by the client device 120 of the first embodiment of this invention.

The client device 120 starts the process in response to entry of an order from a user instructing execution of the process and including a designated key.

First, the client device 120 extracts a key of a piece of data targeted for access from an access request output from the UAP 510 having accepted the order for execution (step S800). More specifically, the data transmitting and receiving unit 520 accepts the access request output from the UAP 510 and extracts a key of a piece of data targeted for access from the access request.

The client device 120 obtains the structure information 350 and the specific key management information 390 from the server 100 (steps S802 and S804). More specifically, the data transmitting and receiving unit 520 obtains the structure information 350 and the specific key management information 390 from the server 100.

The data transmitting and receiving unit 520 can obtain the structure information 350 and the specific key management information 390 from any server 100 connected on the network 130.

Then, the client device 120 refers to the specific key management information 390 to determine whether the piece of data targeted for access is stored in the shared server 110 (step S806). More specifically, the client device 120 executes the following process.

First, the client device 120 calculates a hash value from the key of the piece of data targeted for access using the same algorithm as one used by the server 100. Next, the client device 120 refers to the specific key management information 390 to search for an entry that includes a hash value in the specific key 391 same as the calculated hash value.

In a case where there is no entry including the same hash value, the client device 120 determines that the shared server 110 does not store the piece of data targeted for access.

In a case where there is an entry including the same hash value, the client device 120 refers to the allocation information 392 of this entry to determine whether its storing status 3922 is “already stored.”

In a case where the storing status 3922 is “yet to be stored,” the client device 120 determines that the shared server 110 does not store the piece of data targeted for access.

In a case where the storing status 3922 is “already stored,” the client device 120 determines that the shared server 110 stores the piece of data targeted for access.

In this way, the process in step S806 is completed.

In a case where it is determined that the shared server 110 stores the piece of data targeted for access, the client device 120 determines the shared server 110 as an access destination based on the specific key management information 390 (step S808).

In a case where it is determined that the shared server 110 does not store the piece of data targeted for access, the client device 120 determines a server 100 as an access destination based on the structure information 350 (step S810). A method of determining the server 100 as an access destination based on the structure information 350 is a publicly known method, so that it will not be described.

The client device 120 accesses the determined server 100 or the determined shared server 110 and then completes the process (step S812). More specifically, the data transmitting and receiving unit 520 transmits the access request to the determined server 100 or the determined shared server 110.

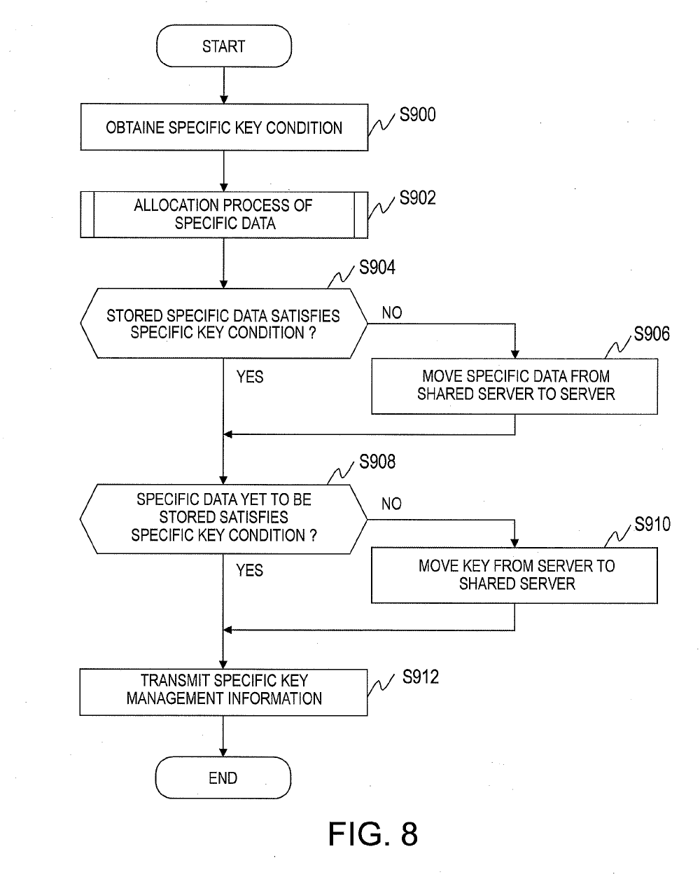

FIG. 8 is a flowchart illustrating process executed by the specific key managing unit 340 of the first embodiment of this invention. The specific key managing unit 340 starts the following process periodically or in accordance with a user's instruction.

The specific key managing unit 340 obtains a specific key condition (step S900). The obtained specific key condition is stored in the main memory device 220.

A specific key condition can be obtained for example by the following method. A file defining a specific key condition is stored in advance in the server 100. At the start of the process, the specific key managing unit 340 reads the definition file. A specific key condition can be entered by means of command input or using a GUI, for example. The specific key managing unit 340 obtains the specific key condition entered in either way.

A specific key condition includes at least information designating a specific key as identification information on specific data, and a condition for storage of specific data. In the first embodiment, a date is entered as the condition for storage of specific data. The following describes an example of a GUI used in the first embodiment for entering a specific key condition.

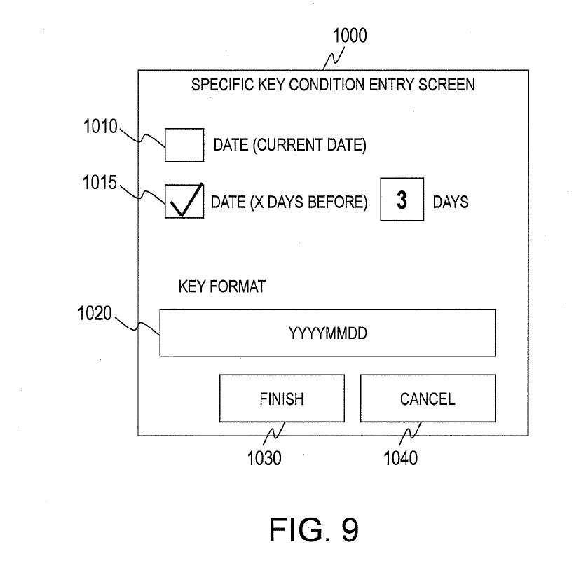

FIG. 9 is an explanatory diagram showing an example of an entry screen for a specific key condition of the first embodiment of this invention.

In the first embodiment, a date and time is entered as a specific key condition.

A date and time is entered as a specific key condition on an entry screen 1000. The entry screen 1000 includes a date designation area 1010, a date designation area 1015, a key format designation area 1020, a finish button 1030, and a cancel button 1040.

The date designation areas 1010 and 1015 are areas where information for designating a specific key is entered. The date designation area 1015 has a check box and a date entry box.

In a case where the date designation area 1010 is operated, “the day of performance of process” is set as information designating a specific key. This shows that data associated with a key in agreement with a date when the process is executed becomes specific data. As an example, in a case where the specific key managing unit 340 executes the process on “Jan. 20, 2012,” data with a key “Jan. 20, 2012” becomes a piece of specific data.

In a case where the date designation area 1015 is operated, “a date X days before performance of process” is set as information designating a specific key. This shows that data associated with a key in agreement with a date earlier by the designated number of days than a date when the process is executed becomes a piece of specific data. In the example of FIG. 9, in a case where the specific key managing unit 340 executes the process on “Jan. 20, 2012,” data with a key “Jan. 17, 2012” becomes a piece of specific data.

The key format designation area 1020 is an area where a key format is entered. A date entered in the date designation area 1010 is designated in a certain key format accordingly. In the example of FIG. 9, where a date is used as a key, “YYYY” indicates a year, “MM” indicates a month, and “DD” indicates a day. A hash value is calculated based on a key format designated in the key format designation area 1020.

The finish button 1030 is an operation button with which information entered in each entry area becomes valid. The cancel button 1040 is an operation button with which information entered in each entry area becomes invalid.

In a case where data is entered on the entry screen 1000 of FIG. 9, a date and time on which the data is entered is set at a condition for storage of specific data.

The description continues by referring back to FIG. 8.

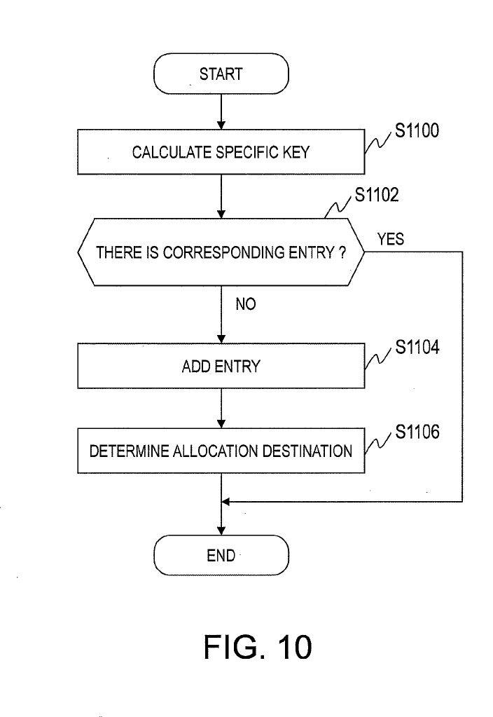

The specific key managing unit 390 executes allocation process of a piece of specific data based on the obtained specific key condition (step S902). This process updates the specific key management information 390. The allocation process of a piece of specific data will be described in detail by referring to FIG. 10.

The specific key managing unit 340 refers to the specific key management information 390 to determine whether at least one of specific data stored in the shared server 110 satisfies the specific key condition (step S904). More specifically, the specific key managing unit 340 executes the following process.

The specific key managing unit 340 refers to the specific key management information 390 to search for an entry with the storing status 3922 “already stored.” Specifically, the specific key managing unit 340 searches for specific data stored in the shared server 110.

Next, the specific key managing unit 340 calculates a hash value based on a specific key condition associated with the search entry.

In a case where “the day of performance of process” is set as information designating a specific key and in a case where “the day of performance of the process” is set as at a condition for storage of specific data, the specific key managing unit 340 executes the following process. The specific key managing unit 340 obtains a date when the process is executed, converts the date to a certain key format, and then calculates a hash value.

In a case where “a date X days before performance of process” is set as information designating a specific key and in a case where “the day of performance of the process” is set as a condition for storage of specific data, the specific key managing unit 340 executes the following process. The specific key managing unit 340 obtains a date when the process is executed, converts a date three days before the obtained date to a certain key format, and then calculates a hash value.

Next, the specific key managing unit 340 determines whether the calculated hash value is the same as a hash value in the specific key 391 of the searched entry.

In a case where the calculated hash value is not the same as the hash value in the specific key 391 of the searched entry, the specific key managing unit 340 determines that the specific key condition is not satisfied. In a case where the calculated hash value is the same as the hash value in the specific key 391 of the searched entry, the specific key managing unit 340 determines that the specific key condition is satisfied.

The specific key managing unit 340 executes the following process, in a case where a particular date is set as information designating a specific key and a particular date is set as a condition for storage of specific data. The specific key managing unit 340 obtains a date when process is executed, and determines whether the obtained date is the same as the date set as a condition for storage of specific data. In a case where the obtained date is the same as the set date, the specific key managing unit 340 determines that the specific key condition is satisfied. In this case, calculating a hash value becomes unnecessary.

In this way, the process in step S904 is completed.

In a case where it is determined that the piece of specific data stored in the shared server 110 satisfies the specific key condition, the specific key managing unit 340 proceeds to step S908.

In a case where it is determined that the piece of specific data stored in the shared server 110 does not satisfy the specific key condition, the specific key managing unit 340 moves the piece of specific data from the shared server 110 to a source server 100 (step S906), and then proceeds to step S908. In this case, the specific key managing unit 340 may delete a corresponding entry from the specific key management information 390.

Next, the specific key managing unit 340 determines whether there is a piece of specific data not stored in the shared server 110 and satisfying the specific key condition (step S908). More specifically, the specific key managing unit 340 executes the following process.

The specific key managing unit 340 refers to the specific key management information 390 to search for an entry with the storing status “yet to be stored.” Specifically, the specific key managing unit 340 searches for a piece of specific data not stored in the shared server 110.

Next, the specific key managing unit 340 determines based on a specific key condition associated with the search entry whether the condition for storage of specific data is satisfied.

As an example, in a case where “the day of performance of process” is designated as a condition for storage of specific data, the specific key managing unit 340 determines that the condition for storage of specific data is satisfied. In a case where a particular date is designated as a condition for storage of specific data, the specific key managing unit 340 determines whether a date and time when the process is executed is the same as a designated date and time. In a case where the date and time when the process is executed is the same as the designated date and time, the specific key managing unit 340 determines that the condition for storage of specific data is satisfied.

In this way, the process in step S908 is completed.

In a case where it is determined that there is no a piece of specific data not stored in the shared server 110 and satisfying the specific key condition, the specific key managing unit 340 proceeds to step S912.

In a case where it is determined that there is a piece of specific data not stored in the shared server 110 and satisfying the specific key condition, the specific key managing unit 340 moves the piece of specific data from the server 100 to the shared server 110 (step S910), and then proceeds to step S912. At this time, the specific key managing unit 340 updates the storing status 3922 of a corresponding entry in the specific key management information 390 to “already stored.”

The specific key managing unit 340 transmits the updated specific key management information 390 to a different server 100 and the client device 120 (step S912), and then completes the process. As a result, a request for access to the piece of specific data is transmitted to the shared server 110.

FIG. 10 is a flowchart illustrating the allocation process of specific data in the first embodiment of this invention.

The specific key managing unit 340 calculates a specific key based on the obtained specific key condition (step S1100). In the first embodiment, the specific key managing unit 340 calculates a hash value.

In a case where “the day of performance of process” is set as a condition for storage of specific data, for example, the specific key managing unit 340 executes the following process. The specific key managing unit 340 obtains a date of the day of performance of process, converts the date to a certain key format, and then calculates a hash value. In a case where “a day three days before a date when process is executed” is set as a condition for storage of specific data, the specific key managing unit 340 executes the following process. The specific key managing unit 340 obtains a date of the day of performance of process, converts a date three days before the obtained date to a certain key format, and then calculates a hash value. In a case where a particular date is set as a specific key condition, the specific key managing unit 340 calculates a hash value from this particular date.

The specific key managing unit 340 refers to the specific key management information 390 to determine whether there is an entry in agreement with the calculated specific key (hash value) (step S1102).

More specifically, the specific key managing unit 340 determines whether there is an entry including the same value in the specific key 391 as the calculated specific key.

In a case where it is determined that there is an entry in agreement with the calculated specific key, the specific key managing unit 340 completes the process.

In a case where it is determined that there is no entry in agreement with the calculated specific key, the specific key managing unit 340 adds a new entry in the specific key management information 390 (step S1104).

More specifically, the specific key managing unit 340 stores the calculated specific key in the specific key 391 of the added entry.

A piece of specific data is determined as a result of the processes of from steps S1100 to S1104.

Next, the specific key managing unit 340 determines a storage area to become an allocation destination of the piece of specific data, specifically determines that the shared server 110 is the allocation destination (step S1106), and then completes the process. There is one shared server 110 in the first embodiment, so that this determination can be omitted. The following process may be executed, in a case where there are multiple shared servers 110.

The specific key managing unit 340 obtains the statistical information 360 from each shared server 110, and determines a shared server 110 of the lowest load as an allocation destination shared server 110. According to a different applicable method, the specific key managing unit 340 calculates the numbers of a plurality of pieces of specific data allocated to the shared servers 110, and determines a shared server 110 with the minimum number of a plurality of piece of specific data allocated to this shared server 110 as an allocation destination shared server 110. The specific key managing unit 340 may also determine an allocation destination shared server 110 such that each of a plurality of pieces of specific data is allocated to a different shared server 110.

After determining the shared server 110, the specific key managing unit 340 stores identification information on the determined shared server 110 in the allocation destination 3921 and stores “yet to be stored” in the storing status 3922 of the added entry.

The specific key managing unit 340 of the first embodiment can present information used to determine whether loads on all the servers 100 are leveled. As an example, the specific key managing unit 340 can generate information necessary for display on a screen using the structure information 350, the statistical information 360, and the specific key management information 390.

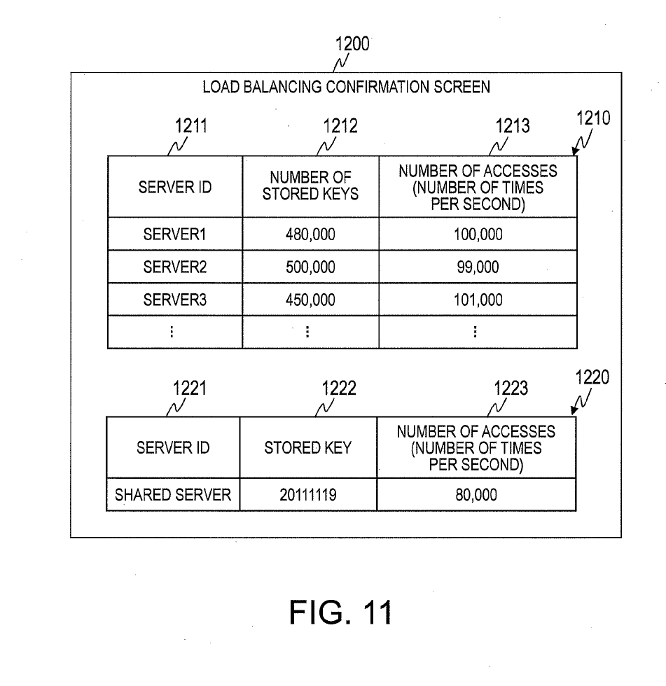

FIG. 11 is an explanatory diagram showing an example of a load balancing confirmation screen 1200 of the first embodiment of this invention.

The load balancing confirmation screen 1200 includes a server status display area 1210 and a shared server status display area 1220. The server status display area 1210 shows a status of a load on each server 100. The shared server status display area 1220 shows a status of a load on the shared server 110.

The server status display area 1210 includes server ID 1211, the number of stored keys 1212, and the number of accesses 1213. The server ID 1211 is an identifier to identify the server 100 uniquely. The number of stored keys 1212 is the number of a plurality of pieces of data actually stored in the server 100. The number of accesses 1213 is the number of accesses per second made to the server 100.

The shared server status display area 1220 includes server ID 1221, stored key 1222, and the number of accesses 1223. The server ID 1221 is an identifier to identify the shared server 110 uniquely. The stored key 1222 is a key of a piece of specific data actually stored in the shared server 110. The number of accesses 1223 is the number of accesses per second made to specific data corresponding to the stored key 1222.

A user can determine a condition to be entered on the entry screen 1000 after checking the load balancing confirmation screen 1200.

In the first embodiment, a specific key condition used for designating a piece of specific data is set in advance. In a case of satisfying the specific key condition, the piece of specific data is moved from the server 100 to the shared server 110 automatically. This allows management of the piece of specific data in a storage area (shared server 110) different from a storage area constructing KVS.

As an example, by storing a piece of data subjected to access concentration in the shared server 110, the shared server 110 can become responsible for process on the piece of data subjected to temporary access concentration. This can realize high-speed process without reducing access performance throughout the computer system constructing KVS.

A piece of specific data not satisfying a specific key condition is moved from the shared server 110 to the server 100 automatically. This can prevent excessive increase of a load on the shared server 110.

[Modifications]

In the first embodiment, a piece of specific data is stored in the shared server 110 for the sake of load balancing, to which this invention is not intended to be limited.

Where a piece of specific data is to be managed separately for reason of security, for example, a value indicating a security level or the like may be used as a key. Where a piece of specific data is to be processed preferentially to other plurality of pieces of data, a value indicating a priority order of process or the like may be used as a key.

Arrangement of a plurality of pieces of data according to KVS is made with the intention of leveling access, so that data corresponding to a certain key cannot be handled specially. However, use of this invention allows management of a piece of specific data in a storage area different from KVS, so that the piece of specific data can be handled specially.

### Second Embodiment

A second embodiment differs from the first embodiment in that it determines a specific key condition based on an access history. The following mainly describes the difference from the first embodiment.

The structure of a calculation system and that of each device of the second embodiment are the same as those of the first embodiment, so that they will not be described.

The client device 120 of the second embodiment executes the same process as that of the first embodiment, so that it will not be descried. The specific key managing unit 340 of the second embodiment executes process differently in that it generates a specific key condition using statistical information in step S900. The process by the specific key managing unit 340 is the same in other respects as that of the first embodiment, so that it will not be described.

The following describes the process of generating a specific key condition using statistical information.

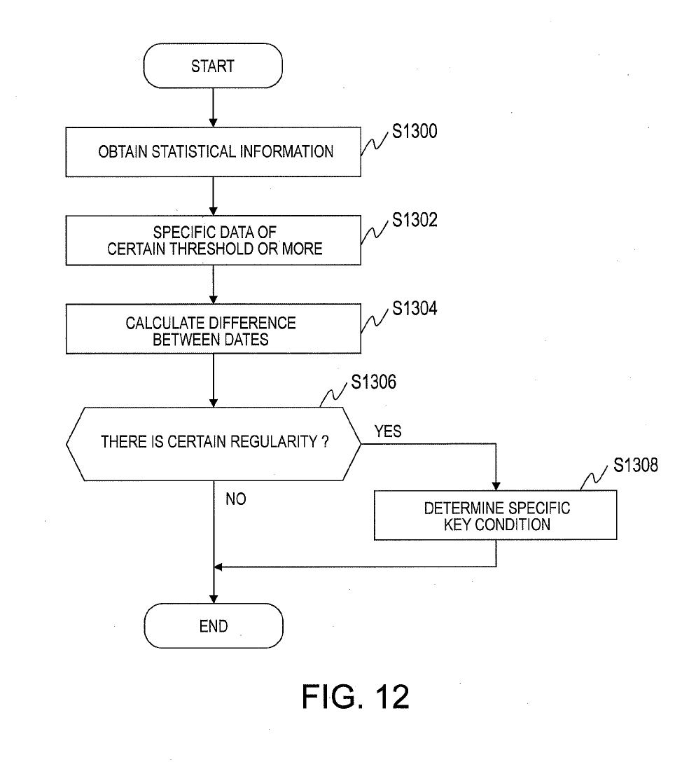

FIG. 12 is a flowchart illustrating the process of generating a specific key condition in the second embodiment of this invention.

The specific key managing unit 340 obtains the statistical information 360 from each server 100 (step S1300). This may be achieved for example by transmitting a request for obtaining of the statistical information 360 from a server 100 executing the process to a different server 100. In a case of received the obtaining request, the server 100 transmits the statistical information 360 and its identifier to the server 100 sending the request.

The specific key managing unit 340 refers to the obtained statistical information 360 to specify a piece of data of the number of accesses of a certain threshold or more (step S1302).

The specific key managing unit 340 refers to the key 361 and the obtained data 362 when a statistical value is obtained about the piece of specified data to calculate a difference between dates (step S1304). In the second embodiment, the specific key managing unit 340 calculates a difference between dates by subtracting the key 361 from the obtained data 362.

The specific key managing unit 340 determines based on the calculated difference between dates whether there is certain regularity (step S1306).

As an example, in a case where accesses of a certain threshold or more are always made to data with regularity when the calculated difference between dates is zero, the specific key managing unit 340 can determine that this data is a piece of specific data to be moved on the day. In a case where accesses of a certain threshold or more are always made to data with regularity when the calculated difference between dates is three, the specific key managing unit 340 can determine that this data is a piece of specific data to be moved three days before a date and time when process is executed. These regularities are given as examples and are not intended to limit this invention.

In a case where it is determined that there is no certain regularity, the specific key managing unit 340 completes the process.

In a case where it is determined that there is certain regularity, the specific key managing unit 340 generates a specific key condition based on this regularity (S1308), and then completes the process.

In the second embodiment, information designating a specific key is determined based on the key 361 of the statistical information 360 and a condition for storage of specific data is determined based on regularity. The specific key managing unit 340 stores a specific key condition including each type of information thereby determined in the main memory device 220.

In the second embodiment, where a specific key condition is not set in advance by a user, it can be generated automatically. This can realize load balancing automatically.

Each type of software described as an example in these embodiments can be stored in various recording media such as electromagnetic, electronic, and optical recording media, and can be downloaded onto computers through communication networks such as the Internet.

Further, control by software is described as an example in these embodiments. Meanwhile, part of the control can also be realized by hardware.

While this invention has been shown and described in detail by referring to the accompanying drawings, this invention is not intended to be limited to the foregoing particular structure but it can cover numerous modifications and equivalent structures within the substance of the attached scope of the claims.

What is claimed is:

1. A computer system comprising a plurality of computers coupled through a network, the computer system performing service by using a database constructed of a storage area of each of the plurality of computers, wherein
each of the plurality of computers includes a processor, a memory coupled to the processor, and a network interface for communicating with another computer via the network which is coupled to the processor,
a plurality of pieces of data are arranged in a distributed manner in units of a management range in each of the plurality of computers constructing the database, the management range being determined by applying a distributed algorithm to identification information on data, and
the computer system comprises:
a management range managing unit to manage the plurality of pieces of data arranged in a distributed manner in each of the plurality of computers constructing the database; and
a specific data managing unit to allocate a specific area to at least one of piece of specific data being at least one of piece of data included in the management range, the specific area being a storage area different from the storage area constructing the database.

2. The computer system according to claim 1, wherein
the specific data managing unit holds specific data management information including the identification information on a piece of specific data and identification information on the specific area,
the specific data managing unit is configured to:
refer to the specific data management information to search for at least one of piece of specific data not stored in the specific area from a plurality of pieces of specific data, and
move the searched at least one of piece of specific data from the database to the specific area.

3. The computer system according to claim 2, wherein
the specific data managing unit holds a designation condition including information for determining the at least one of piece of specific data and a storage condition of the at least one of piece of specific data,
the specific data managing unit is configured to:
refer to the specific data management information to search for first specific data not stored in the specific area, and then determines whether the first specific data satisfies the storage condition,
move the first specific data from the database to the specific area, in a case where the first specific data satisfies the storage condition,
refer to the specific data management information to search for second specific data stored in the specific area, and then determines whether the second specific data satisfies the storage condition, and
move the second specific data from the specific area to the database, in a case where the second specific data does not satisfy the storage condition.

4. The computer system according to claim 3, wherein
the specific data managing unit is configured to:
determine the at least one of piece of specific data based on the designation condition,
determine the specific area to be allocated to the determined at least one of piece of specific data, and
generate the specific data management information based on identification information on the determined at least one of piece of specific data and identification information on the specific area.

5. The computer system according to claim 4, comprising a statistics managing unit to manage statistical information indicating an operating state about each of the plurality of computers constructing the database,
wherein the specific data managing unit is configured to analyze the statistical information to determine the designation condition.

6. The computer system according to claim 4, wherein
the computer system includes a plurality of the specific areas,
the specific data managing unit is configured to determine the plurality of specific areas to be allocated to a plurality of pieces of specific data such that all the specific areas which are allocated to each of the plurality of pieces of specific data are different.

7. The computer system according to claim 2, wherein
the specific data management information includes status information indicating whether the at least one of piece of specific data is stored in the specific area,
the specific data managing unit is configured to:
move the at least one of piece of specific data from the database to the specific area and then update the status information, and
notify transmitting a request for access to the at least one of piece of specific data to the specific area.

8. A data management method to be implemented in a computer system including a plurality of computers connected through a network, the computer system performing service by using a database constructed of a storage area of each of the plurality of computers, wherein
each of the plurality of computers includes a processor, a memory coupled to the processor, and a network interface for communicating with another computer via the network which is coupled to the processor,
a plurality of pieces of data are arranged in a distributed manner in units of a management range in each of the plurality of computers constructing the database, the management range being determined by applying a distributed algorithm to identification information about the data, and
the method includes:
a step of controlling, by the computer, access to the data included in the management range; and
a step of allocating, by the computer, a specific area to at least one of piece of specific data being at least one of piece of data stored in the database, the specific area being a storage area different from the storage area constructing the database.

9. The data management method according to claim 8, wherein
each of the computers holds specific data management information including the identification information on a piece of specific data and identification information on the specific area, and
the method further includes:
a first step of referring, by the computer, to the specific data management information to search for at least one of piece of specific data not stored in the specific area from a plurality of pieces of specific data; and
a second step of moving, by the computer, the searched at least one of piece of specific data from the database to the specific area.

10. The data management method according to claim 9, wherein
each of the computers holds a designation condition including information for determining the at least one of piece of specific data and a storage condition of the at least one of piece of specific data,
the first step includes:
a step of referring, by the computer, to the specific data management information to search for first specific data not stored in the specific area, and then determining whether the first specific data satisfies the storage condition; and
a step of moving, by the computer, the first specific data from the database to the specific area, in a case where the first specific data satisfies the storage condition,
the method further includes:
a step of referring, by the computer, to the specific data management information to search for second specific data stored in the specific area, and then determining whether the second specific data satisfies the storage condition; and
a step of moving, by the computer, the second specific data from the specific area to the database, in a case where the second specific data does not satisfy the storage condition.

11. The data management method according to claim 10, including:
a third step of determining, by the computer, the at least one of piece of specific data based on the designation condition;
a fourth step of determining, by the computer, the specific area to be allocated to the determined at least one of piece of specific data; and
a fifth step of generating, by the computer, the specific data management information based on identification information on the determined at least one of piece of specific data and identification information on the specific area.

12. The data management method according to claim 11, wherein
each of the computers holds statistical information indicating an operating state about each of the plurality of computers constructing the database, and
the method includes a step of analyzing, by the computer, the statistical information to determine the designation condition.

13. The data management method according to claim 11, wherein
the specific area in the computer system includes a plurality of specific areas, and
in the fourth step, the computer determines the plurality of specific areas to be allocated to a plurality of piece of specific data such that all the specific areas which are allocated to each of the plurality of pieces of specific data are different.

14. The data management method according to claim 9, wherein
the specific data management information includes status information indicating whether the specific data is stored in the specific area, and
the second step includes:
a step of moving, by the computer, the at least one of piece of specific data from the database to the specific area and then updating the status information; and
a step of notifying, by the computer, transmitting a request for access to the specific data to the specific area.

15. A non-transitory computer readable medium storing a program executed by each of a plurality of computers in a computer system where the plurality of computers are connected through a network each other, the computer system performing service by using a database constructed of a storage area of each of the plurality of computers, wherein
each of the plurality of computers includes a processor, a memory coupled to the processor, and a network interface for communicating with another computer via the network which is coupled to the processor,
a plurality of pieces of data are arranged in a distributed manner in units of a management range in each of the plurality of computers constructing the database, the management range being determined by applying a distributed algorithm to identification information on data, and
the program makes a computer perform:
a procedure of controlling access to the data included in the management range; and
a procedure of allocating a specific area to at least one of piece of specific data being a storage area different from the storage area constructing the database.

16. The non-transitory computer readable medium storing a program according to claim 15, wherein
the computer holds specific data management information including the identification information on a piece of specific data and identification information on the specific area, and
the program makes the computer perform:
a first procedure of referring to the specific data management information to search for at least one of piece of specific data not stored in the specific area from the specific data; and
a second procedure of moving the searched at least one of piece of specific data from the database to the specific area.

17. The non-transitory computer readable medium storing a program according to claim 16, wherein
the computer holds a designation condition including information for determining the at least one of piece of specific data and a storage condition of the at least one of specific data,
the first procedure includes:
a procedure of referring to the specific data management information to search for first specific data not stored in the specific area, and then determining whether the first specific data satisfies the storage condition; and
a procedure of moving the first specific data from the database to the specific area, in a case where the first specific data satisfies the storage condition,
the program further makes the computer perform:
a procedure of referring to the specific data management information to search for second specific data stored in the specific area, and then determining whether the second specific data satisfies the storage condition; and
a procedure of moving the second specific data from the specific area to the database, in a case where the second specific data does not satisfy the storage condition.

18. The non-transitory computer readable medium storing a program according to claim 17, wherein
the program further makes the computer perform:
a procedure of determining the at least one of piece of specific data based on the designation condition;
a procedure of determining the at least one of piece of specific area to be allocated to the determined at least one of piece of specific data; and
a procedure of generating the specific data management information based on identification information on the determined at least one of piece of specific data and identification information about the specific area.

19. The non-transitory computer readable medium storing a program according to claim 18, wherein
the computer holds statistical information indicating an operating state about each of the plurality of computers constructing the database, and
the program makes the computer perform a procedure of analyzing the statistical information to determine the designation condition.

20. The non-transitory computer readable medium storing a program according to claim 16, wherein
the specific data management information includes status information indicating whether the at least one of piece of specific data is stored in the specific area, and
the second procedure includes procedures to be performed by the computer, the procedures including:
a procedure of moving the at least one of piece of specific data from the database to the specific area and then updating the status information; and
a procedure of notifying transmitting a request for access to the at least one of piece of specific data is transmitted to the specific area.
